(19) United States
(12) Patent Application Publication
(10) Pub. No.: US 2025/0124458 A1
(43) Pub. Date: Apr. 17, 2025

(54) Brand Value Evaluation Method, Device, Computer Equipment and Storage Medium

(71) Applicant: Shenzhen Donson Cloud Technology Co., Ltd., Shenzhen (CN)

(72) Inventors: Yang Liu, Shenzhen (CN); Jie Chen, Shenzhen (CN); Yue Lin, Shenzhen (CN); Pinyin Lu, Shenzhen (CN); Yunyang Li, Shenzhen (CN)

(21) Appl. No.: 18/537,857

(22) Filed: Dec. 13, 2023

(30) Foreign Application Priority Data
Oct. 16, 2023 (CN) 202311345503.8

(51) Int. Cl. G06Q 30/0201

(52) U.S. Cl. CPC G06Q 30/0201

(57) ABSTRACT

Disclosed is a brand value evaluation method, comprising: acquiring a brand set to be processed containing a plurality of brands to be processed; collecting evaluation data corresponding to the brand set to be processed, and identifying the brand set to be processed based on the evaluation data to obtain a reputation degree and a volume of each brand to be processed in the brand set to be processed; acquiring a brand to be evaluated, and judging whether the brand to be evaluated exists in the brand set to be processed; when it exists, determining the reputation degree and volume of the brand to be evaluated as a target reputation degree and a target volume; determining a value for the brand to be evaluated according to the reputation degree of each brand to be processed, the volume of each brand to be processed, the target reputation degree and the target volume.

### CROSS REFERENCE TO RELATED APPLICATIONS

The present application claims the benefit of Chinese Patent Application No. 202311345503.8 filed on Oct. 16, 2023, the contents of which are incorporated herein by reference in their entirety.

### TECHNICAL FIELD

The application relates to the field of data processing, in particular to a brand value evaluation method, device, computer equipment and storage medium.

### BACKGROUND

With the rapid development of digitalization, in the field of e-commerce, brand reputation degree has become an important reference for consumers to shop.

Brand reputation degree refers to consumers' overall impression and degree of trust in a brand. It is a crucial concept in brand management, because it directly affects consumers' purchase decision and loyalty. The evaluation of brand reputation degree may be influenced by many factors, including brand volume, social media feedback, word of mouth, customer satisfaction and so on. At present, the commonly used brand reputation degree evaluation methods are questionnaire and customer satisfaction survey, which requires a lot of human resources and takes a long time, and the final results are often difficult to meet expectations.

### SUMMARY

The embodiments of the application provide a brand value evaluation method, device, computer equipment and storage medium, aiming at improving the accuracy and comprehensiveness of brand value evaluation.

Provided is a brand value evaluation method, including:
acquiring a brand set to be processed; the brand set to be processed includes a plurality of brands to be processed;
collecting evaluation data corresponding to the brand set to be processed, and identifying the brand set to be processed based on the evaluation data to obtain a reputation degree and a volume of each brand to be processed in the brand set to be processed;
acquiring a brand to be evaluated, and judging whether the brand to be evaluated exists in the brand set to be processed;
when the brand to be evaluated exists, determining the reputation degree and volume of the brand to be evaluated as a target reputation degree and a target volume; and
determining a value for the brand to be evaluated according to the reputation degree of each brand to be processed, the volume of each brand to be processed, the target reputation degree and the target volume.

Provided is a brand value evaluation device, including:
a brand set acquisition module, configured to acquire a brand set to be processed; the brand set to be processed includes a plurality of brands to be processed;
a brand set identification module, configured to collect evaluation data corresponding to the brand set to be processed, and identify the brand set to be processed based on the evaluation data to obtain a reputation degree and a volume of each brand to be processed in the brand set to be processed;
a brand to be evaluated judging module, configured to acquire a brand to be evaluated, and judge whether the brand to be evaluated exists in the brand set to be processed;
a brand to be evaluated determining module, configured to, when the brand to be evaluated exists, determine the reputation degree and volume of the brand to be evaluated as a target reputation degree and a target volume; and
a brand value determination module, configured to determine a value for the brand to be evaluated according to the reputation degree of each brand to be processed, the volume of each brand to be processed, the target reputation degree and the target volume.

Provided is a computer equipment, including a memory, a processor and a computer program stored in the memory and executable by the processor, when the processor executes the computer program, the above brand value evaluation method is realized.

Provided is a computer equipment, including a memory, a processor and a computer program stored in the memory and executable by the processor, when the processor executes the computer program, the above brand value evaluation method is realized.

The above brand value evaluation method, device, computer equipment and storage medium are provided. And the method works as follows: acquiring a brand set to be processed; the brand set to be processed includes a plurality of brands to be processed; collecting evaluation data corresponding to the brand set to be processed, and identifying the brand set to be processed based on the evaluation data to obtain a reputation degree and a volume of each brand to be processed in the brand set to be processed; acquiring a brand to be evaluated, and judging whether the brand to be evaluated exists in the brand set to be processed; when the brand to be evaluated exists, determining the reputation degree and volume of the brand to be evaluated as a target reputation degree and a target volume; and finally determining a value for the brand to be evaluated according to the reputation degree of each brand to be processed, the volume of each brand to be processed, the target reputation degree and the target volume.

According to the present application, the combination of brand awareness and consumers' emotional tendency to the brand is realized, which improves the accuracy and comprehensiveness of brand value evaluation.

### BRIEF DESCRIPTION OF THE DRAWINGS

In order to explain the technical solution of the embodiments of this application more clearly, the drawings described in the description of the embodiments of this application will be briefly introduced below. Obviously, the drawings in the present application and their accompanying detailed description are directed to merely exemplary embodiments of the application. F or those of ordinary skill in this field, other drawings may be obtained according to these drawings without any creative effort.

FIG. 1 is a flowchart of a brand value evaluation method provided by an embodiment of the present application;

FIG. 2 is a structural diagram of a brand value evaluation device provided by an embodiment of the present application;

FIG. 3 is a schematic diagram of a computer equipment provided by an embodiment of the present application.

### DETAILED DESCRIPTION OF PREFERRED EMBODIMENTS

The technical solutions in the embodiments of the present application will be clearly and completely described below with reference to the drawings in the embodiments of this application. Obviously, the described embodiments are part of the embodiments of this application, but not all of them. Based on the embodiments in this application, all other embodiments obtained by those of ordinary skill in the art without creative effort belong to the protection scope of this application.

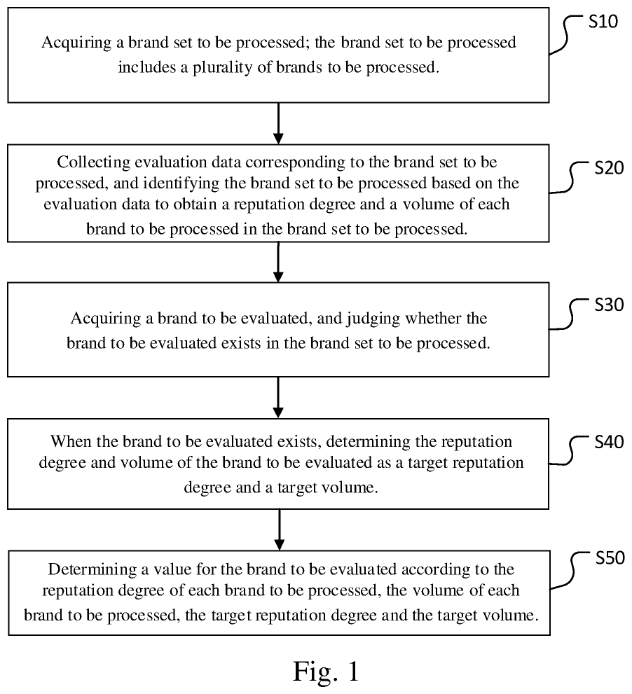

In an embodiment, as shown in FIG. 1, a brand value evaluation method is provided, which includes the following steps S10-S50.

S10: acquiring a brand set to be processed; the brand set to be processed includes a plurality of brands to be processed.

Understandably, the brand set to be processed may be a collection of multiple brands to be processed, where all brands to be processed in the brand set to be processed may be different brands in the same field preset. The brand set to be processed may be a preset brand set to be processed or a brand set to be processed automatically crawled from the network according to a preset field.

Specifically, according to the preset brand field and preset crawling rules, a web crawler is adopted to automatically crawl a plurality of brands to be processed related to the field on the Internet to form a brand set to be processed. Here, the brand field includes, but is not limited to, watches, sports shoes, maternal, mother and baby products, and the preset crawling rule may be crawling brands whose brand popularity is greater than or equal to a preset popularity threshold.

S20: collecting evaluation data corresponding to the brand set to be processed, and identifying the brand set to be processed based on the evaluation data to obtain a reputation degree and a volume of each brand to be processed in the brand set to be processed.

Understandably, the evaluation data may be consumers' comments and opinions on brands on social media. The brand reputation degree may be a numerical value reflecting the degree of trust, goodwill, acceptance and popularity of the brand to the public. The brand volume may be a numerical value that reflects the volume generated by the brand presentation, interaction with consumers and other brand promotion activities via a specific channel or platform, thus representing the brand's popularity and influence in the public.

Specifically, the brand set to be processed is collected through a preset data collection model to obtain evaluation data corresponding to each brand in the brand set to be processed, and the reputation degree and volume of each brand in the brand set to be processed are obtained according to the evaluation data of each brand to be processed and each brand to be processed.

S30: acquiring a brand to be evaluated, and judging whether the brand to be evaluated exists in the brand set to be processed.

Understandably, in this embodiment, the brand field of the brand to be evaluated and the brand set to be processed are the same.

Specifically, the brand to be evaluated is obtained, and it is judged whether there is a brand identical to the brand to be evaluated in the brand set to be processed.

S40: when the brand to be evaluated exists, determining the reputation degree and volume of the brand to be evaluated as a target reputation degree and a target volume.

Specifically, if there is an identical brand to the brand to be evaluated in the brand set to be processed, the reputation degree and volume corresponding to this brand are selected from the reputation degree and volume of each brand to be processed, and the selected reputation degree and volume are determined as a target reputation degree and a target volume.

S50: determining a value for the brand to be evaluated according to the reputation degree of each brand to be processed, the volume of each brand to be processed, the target reputation degree and the target volume.

Understandably, brand value includes but is not limited to brand awareness, brand fine reputation value and brand fine reputation degree.

Specifically, the reputation of each brand to be processed, volume of each brand to be processed, target reputation degree and target volume are input into a preset brand value evaluation model, and the value of the brand to be evaluated is determined according to the output result of the brand value evaluation model. Here, the preset brand value evaluation model may be a preset brand value evaluation model according to actual needs.

In this embodiment, the brand set to be processed is acquired, the evaluation data corresponding to the brand set to be processed is collected, and the brand set to be processed is identified according to the evaluation data, so as to obtain the reputation and volume of each brand in the brand set to be processed, then a brand to be evaluated is acquired, and whether the brand to be evaluated exists in the brand set to be processed is determined; when the brand to be evaluated exists, the reputation degree and volume of the brand to be evaluated are determined as a target reputation degree and a target volume; and a value for the brand to be evaluated is determined according to the reputation degree of each brand to be processed, the volume of each brand to be processed, the target reputation degree and the target volume. According to this embodiment, the combination of brand reputation degree and brand volume is realized, and the market and consumers' multi-faceted cognition and brand popularity are fully considered, thereby improving the accuracy and comprehensiveness of brand value evaluation, thus providing objective data support for enterprises, helping enterprises to better understand and evaluate the market competitiveness and potential value of brands to be evaluated, so as to make more informed business decisions.

In an embodiment, step S20, i.e., collecting evaluation data corresponding to the brand set to be processed, and identifying the brand set to be processed based on the evaluation data to obtain a reputation degree and a volume of each brand to be processed in the brand set to be processed, further includes:

S201: collecting evaluation data corresponding to each brand to be processed in the brand set to be processed according to a preset data collection rule, and the evaluation data includes social comment data and brand appearance frequency of each brand to be processed. Understandably, the preset data collection rule may be preset according to needs. In this embodiment, the preset data collection rule may be to collect evaluation data related to the brand to be processed on a plurality of designated social platforms within a preset time period. The social comment data may be the comments of brands from users on social media. The brand appearance frequency may be the amount of brand-related information on social platforms.

S202: determining a reputation degree corresponding to each brand to be processed according to the social comment data of the brand to be processed.

S203: calculating to obtain a total brand appearance frequency corresponding to all the brands to be processed according to the brand appearance frequency, and determining a volume corresponding to each brand to be processed according to the brand appearance frequency corresponding to each brand to be processed and the total brand appearance frequency of all the brands to be processed.

Specifically, in a preset time period and on a plurality of designated social platforms, social comment data and brand appearance frequency corresponding to each brand to be processed in the brand set to be processed are crawled through a web crawler. According to the social comment data of each brand to be processed, the reputation degree corresponding to the brand to be processed is determined, the brand appearance frequencies corresponding to all the brands to be processed are added to obtain a total brand appearance frequency corresponding to the brand set to be processed, the ratio of the brand appearance frequency of the brand to be processed to the total brand appearance frequency is calculated, and the obtained ratio is determined as the volume corresponding to the brand to be processed.

This embodiment collects the evaluation data corresponding to each brand to be processed in the brand set to be processed according to the preset data collection rule, determines the reputation degree corresponding to the brand to be processed according to the social comment data of each brand to be processed, calculates the total brand appearance frequency corresponding to the brand to be processed according to the brand appearance frequency corresponding to each brand to be processed, and determines the volume corresponding to each brand to be processed according to the brand appearance frequency corresponding to each brand to be processed and the total brand appearance frequency of all brands to be processed. In this way, a comprehensive consideration of brand reputation degree and volume can be given, and the market performance and potential value of the brand can be evaluated more accurately, thus providing important reference for business decision-making, helping enterprise to make better use of brand resources, plan marketing strategies and enhance brand competitiveness.

In an embodiment, step S202, i.e., determining a reputation degree corresponding to each brand to be processed according to the social comment data of the brand to be processed, further includes:

S2021: acquiring all social comment data corresponding to one single brand to be processed.

S2022: performing emotion recognition on each social comment data through a preset emotion recognition model to obtain an evaluation result corresponding to the social comment data, and the evaluation result includes a positive evaluation result and a negative evaluation result. Understandably, the preset emotion recognition model may be a preset trained emotion recognition model according to needs. Here, the emotion recognition model is able to determine whether the evaluation is positive or negative by judging the sentiment polarity in the text based on natural language processing and machine learning technology. Emotion recognition of each social comment data may be a process of determining the emotional type of social comment data by extracting emotional keywords from the social comment data, so as to determine the evaluation result of social comment data. Here, if the social comment data is audio data, the social comment data would first be converted into text data, and then the emotional keywords are extracted.

S2023: determining a reputation degree for the brand to be processed according to the positive evaluation result and the negative evaluation result respectively corresponding to all the social comment data. Understandably, the step of determining a reputation degree for the brand to be processed according to the positive evaluation result and the negative evaluation result may be a process of calculating the difference between the number of social comment data of all positive evaluation result corresponding to the brand to be processed and the number of social comment data of all negative evaluation result corresponding to the brand to be processed, and then calculating the ratio of the difference to the number of all social comment data corresponding to the brand to be processed, thereby obtaining the reputation degree of the brand to be processed. In this embodiment, the value range of reputation degree is −1˜+1. If the reputation degree is positive, it indicates that there are more positive comments than negative comments, and the brand is more likely to be popular with consumers. If the reputation degree is negative, it indicates that there are more negative comments than positive comments, and the brand may not be welcomed by consumers. If the reputation degree is 0, it means that positive comments equal negative comments, and the brand's popularity with consumers is neither good nor bad. The number of social comment data of positive evaluation result may be P, the number of social comment data of negative evaluation result may be N, the number of all social comment data would be P+N, the reputation degree may be NSR, and the calculation formula of reputation degree is:

$$NSR = \frac{P - N}{P + N}$$

Specifically, the step of acquiring all social comment data corresponding to one single brand to be processed refers to: identifying the data types of all social comment data, if there is any social comment data with audio type, converting the audio type into text type until all the social comment data are text type. Extracting emotional keywords from all the social comment data, determining a sentiment polarity (positive or negative) for each social comment data according to the emotional keywords corresponding to each social comment data, determining an evaluation result (positive or negative) for each social comment data according to the sentiment polarity of each social comment data, calculating the difference N between the number P of social comment data of all positive evaluation result and the number N of social comment data of all negative evaluation result, and then calculating the ratio of the difference to the number P+N of all social comment data, finally determining the obtained ratio as the reputation degree NSR of the brand to be processed.

In this embodiment, all social comment data corresponding to the same brand to be processed are obtained, and each social comment data is subjected to emotion recognition through a preset emotion recognition model to obtain an evaluation result corresponding to the social comment data. The evaluation result includes a positive evaluation result and a negative evaluation result, the reputation degree of the brand to be processed is determined according to the positive evaluation result and negative evaluation result corresponding to all social comment data respectively. In this way, the determination of brand reputation degree is realized, so as to understand the popularity and reputation degree of the brand on social media.

In an embodiment, after step S30, i.e., judging whether the brand to be evaluated exists in the brand set to be processed, it further includes:

S401: when the brand to be evaluated does not exist, updating and adding the brand to be evaluated as a brand to be processed into the brand set to be processed.

S402: collecting evaluation data corresponding to the brand to be evaluated according to a preset data collection rule to obtain a target reputation degree and a target volume corresponding to the brand to be evaluated.

S403: determining a value for the brand to be evaluated according to the reputation degree of each brand to be processed, the volume of each brand to be processed, the target reputation degree and the target volume.

Specifically, if there is no brand identical to the brand to be evaluated in the brand set to be processed, the brand to be evaluated is added to the brand set to be processed to obtain an updated brand set to be processed; social comment data and brand appearance frequency corresponding to the brand to be evaluated are crawled by a web crawler in a preset time period and on a plurality of designated social platforms, and the updated brand set to be processed is updated according to the social comment data and brand appearance frequency corresponding to the brand to be evaluated, then the reputation degree and volume of the brand to be evaluated and the reputation degree and volume of each updated brand to be processed are obtained, so the value of the brand to be evaluated is determined according to the reputation degree of each brand to be processed, the volume of each brand to be processed, the target reputation degree and the target volume.

In this embodiment, if there is no brand to be evaluated, the brand to be evaluated is updated and added to the brand set to be processed, the comment data corresponding to the brand to be evaluated is collected according to the preset data collection rules, and the target reputation degree and target volume corresponding to the brand to be evaluated are obtained, so the value of the brand to be evaluated is determined according to the reputation degree of each brand to be processed, the volume of each brand to be processed, the target reputation degree and the target volume. Therefore, when the brand to be evaluated is updated, the reputation degree and value of the brand and other related data of the brand to be processed can be obtained and updated in time, and the real-time update of the brand reputation is realized.

In an embodiment, step S50, i.e., determining a value for the brand to be evaluated according to the reputation degree of each brand to be processed, the volume of each brand to be processed, the target reputation degree and the target volume, includes:

S501: determining an average reputation degree for all brands to be processed according to the reputation degree of each brand to be processed.

S502: determining an average volume for all brands to be processed according to the volume of each brand to be processed.

S503: inputting the reputation degree of the brand to be evaluated, the volume of the brand to be evaluated, the average reputation degree and the average volume into a preset fine reputation value generation model to obtain a fine reputation value of the brand to be evaluated output by the fine reputation value generation model, and determining a value for the brand to be evaluated according to the fine reputation value. Understandably, the preset fine reputation value generation model may reflect the input fine reputation value of the brand to be evaluated. The reputation degree of the brand to be evaluated may be nᵢ, the volume of the brand to be evaluated may be vᵢ, the average reputation degree may be n̅ᵢ, the average volume may be v̅ᵢ, and the fine reputation value generation model may be:

$${x}_{i} = \frac{{n}_{i} {v}_{i} + {\overline{n}}_{i} {\overline{v}}_{i}}{{\overline{v}}_{i} + {v}_{i}}$$

xᵢ the fine reputation value of the brand to be evaluated.

Specifically, the ratio of the sum of the reputation degrees of all brands to be processed to the number of all brands to be processed is calculated, the average reputation degree n̅ᵢ of all brands to be processed is determined, the ratio of the sum of the volumes of all brands to be processed to the number of all brands to be processed is calculated, and the average volume v̅ᵢ of all brands to be processed is determined. The reputation degree nᵢ of the brand to be evaluated, the volume vᵢ of the brand to be evaluated, the average reputation degree n̅ᵢ and the average volume v̅ᵢ are input into the fine reputation value generation model to obtain a fine reputation value xᵢ of the brand to be evaluated, then the value of the brand to be evaluated is determined according to the fine reputation value xᵢ of the brand to be evaluated. For instance, the fine reputation value xᵢ of the brand to be evaluated is compared with a preset fine reputation degree threshold, the reputation degree nᵢ of the brand to be evaluated, the volume vᵢ of the brand to be evaluated, the average reputation degree n̅ᵢ and the average volume v̅ᵢ, and then the specific improvement points of the brand to be evaluated are determined, so that the specific improvement solution of the brand to be evaluated is realized. If the fine reputation value xᵢ of the brand to be evaluated is greater than the preset fine reputation degree threshold, nᵢ is larger, and vᵢ is smaller than v̅ᵢ, it indicates that the brand to be evaluated is highly welcomed by consumers and is ready to be vigorously promoted.

In this embodiment, the average reputation degree of all brands to be processed is determined according to the reputation degree of each brand to be processed, the average volume of all brands to be processed is determined according to the volume of each brand to be processed, and the reputation degree of the brand to be evaluated, the volume of the brand to be evaluated, the average reputation degree and the average volume are input into the preset fine reputation value generation model to obtain a fine reputation value of the brand to be evaluated output by the fine reputation value generation model, and the value of the brand to be evaluated is determined according to the fine reputation value. In this way, the objective evaluation of the brand value to be evaluated is obtained, thus providing a decision-making basis based on data, which enables enterprises to make targeted improvements to their brands.

In an embodiment, after step S503, i.e., determining a value for the brand to be evaluated according to the fine reputation value, the method further includes:

S504: decentralizing the fine reputation value of the brand to be evaluated to obtain a fine reputation value standard score of the brand to be evaluated. Understandably, the standard score can reflect the relative standard distance between the fine reputation value and the average fine reputation value of the evaluated brand. The standard score calculation formula is:

$${z}_{i} = \frac{{x}_{i} - \overline{x}}{σ}$$

x̅ is average fine reputation value of all brands to be processed, σ is standard deviation of fine reputation value, zᵢ is fine reputation value standard score of the brand to be evaluated.

S505: normalizing the fine reputation value standard score of the brand to be evaluated to obtain a fine reputation degree of the brand to be evaluated, and determining a value for the brand to be evaluated according to the fine reputation degree. The normalization formula is:

$$R = \frac{75}{1 + {e}^{- 4 {z}_{i}}} + 25$$

R is the fine reputation degree of the brand to be evaluated.

Specifically, based on standard score calculation formula, the fine reputation value of the brand to be evaluated is decentralized to obtain a fine reputation value standard score zᵢ of the brand to be evaluated; and the fine reputation value standard score zᵢ of the brand to be evaluated is normalized to obtain a fine reputation degree R of the brand to be evaluated, then the value of the brand to be evaluated is determined according to the size of the fine reputation degree R of the brand to be evaluated. In this way, we can objectively evaluate and compare the reputations of different brands and provide a unified standard to measure the value of brands, thus helping enterprises to make more accurate decisions.

It should be understood that the sequence number of each step in the following embodiment does not imply the order of execution, and the order of execution of each process should be determined according to the function and internal logic, and shall not constitute any limitation on the implementation process of the embodiment of the present invention.

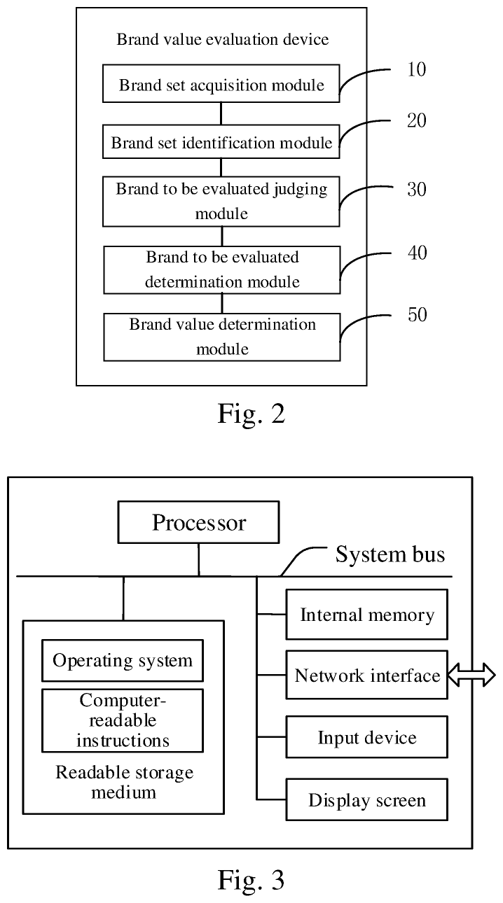

In an embodiment, a brand value evaluation device is provided, which corresponds to the brand value evaluation method in the above embodiments one by one. As shown in FIG. 2, the brand value evaluation device includes a brand set acquisition module 10, a brand set identification module 20, a brand to be evaluated judging module 30, a brand to be evaluated determination module 40, and a brand value determination module 50. The detailed explanation of each functional module is as follows:
a brand set acquisition module 10, configured to acquire a brand set to be processed; the brand set to be processed includes a plurality of brands to be processed.
a brand set identification module 20, configured to collect evaluation data corresponding to the brand set to be processed, and identify the brand set to be processed based on the evaluation data to obtain a reputation degree and a volume of each brand to be processed in the brand set to be processed.
a brand to be evaluated judging module 30, configured to acquire a brand to be evaluated, and judge whether the brand to be evaluated exists in the brand set to be processed.
a brand to be evaluated determination module 40, configured to, when the brand to be evaluated exists, determine the reputation degree and volume of the brand to be evaluated as a target reputation degree and a target volume.
a brand value determination module 50, configured to determine a value for the brand to be evaluated according to the reputation degree of each brand to be processed, the volume of each brand to be processed, the target reputation degree and the target volume.

Preferably, the brand set identification module 20 includes:
a frequency calculation unit, configured to collect evaluation data corresponding to each brand to be processed in the brand set to be processed according to a preset data collection rule, and the evaluation data includes social comment data and brand appearance frequency of each brand to be processed;
a reputation degree determination unit, configured to determine a reputation degree corresponding to each brand to be processed according to the social comment data of the brand to be processed; and
a volume determination unit, configured to calculate to obtain a total brand appearance frequency corresponding to all the brands to be processed according to the brand appearance frequency, and determine a volume corresponding to each brand to be processed according to the brand appearance frequency corresponding to each brand to be processed and the total brand appearance frequency of all the brands to be processed.

Preferably, the reputation degree determination unit includes:
a social comment data acquisition subunit, configured to acquire all social comment data corresponding to one single brand to be processed;
an evaluation result acquisition subunit, configured to perform emotion recognition on each social comment data through a preset emotion recognition model to obtain an evaluation result corresponding to the social comment data, and the evaluation result includes a positive evaluation result and a negative evaluation result.
a reputation degree acquisition subunit, configured to determine a reputation degree for the brand to be processed according to the positive evaluation result and the negative evaluation result respectively corresponding to all the social comment data.

Preferably, the brand to be evaluated judging module 30 includes:
a brand set to be processed updating unit, configured to, when the brand to be evaluated does not exist, update and add the brand to be evaluated as a brand to be processed into the brand set to be processed;
a reputation degree and volume updating unit, configured to collect evaluation data corresponding to the brand to be evaluated according to a preset data collection rule to obtain a target reputation degree and a target volume corresponding to the brand to be evaluated;
a brand to be processed updating unit, configured to determine a value for the brand to be evaluated according to the reputation degree of each brand to be processed, the volume of each brand to be processed, the target reputation degree and the target volume.

Preferably, the brand value determination module 50 includes:
an average reputation degree determination unit, configured to determine an average reputation degree for all brands to be processed according to the reputation degree of each brand to be processed;
an average volume determination unit, configured to determine an average volume for all brands to be processed according to the volume of each brand to be processed;
a fine reputation value generation unit, configured to input the reputation degree of the brand to be evaluated, the volume of the brand to be evaluated, the average reputation degree and the average volume into a preset fine reputation value generation model to obtain a fine reputation value of the brand to be evaluated output by the fine reputation value generation model, and determine a value for the brand to be evaluated according to the fine reputation value.

Preferably, the fine reputation value generation unit further includes:
a fine reputation value standard score acquisition subunit, configured to decentralize the fine reputation value of the brand to be evaluated to obtain a fine reputation value standard score of the brand to be evaluated;
a fine reputation degree generation subunit, configured to normalize the fine reputation value standard score of the brand to be evaluated to obtain a fine reputation degree of the brand to be evaluated, and determine a value for the brand to be evaluated according to the fine reputation degree.

For the specific definition of the brand value evaluation device, please refer to the definition of the brand value evaluation method above, which will not be repeated here. Each module in the above-mentioned brand value evaluation device may be realized in whole or in part by software, hardware and their combinations. The above modules may be embedded in or independent from the processor in the computer equipment in the form of hardware, and may also be stored in the memory in the computer equipment in the form of software, so that the processor can call and execute the operations corresponding to the above modules.

In one embodiment, a computer equipment is provided, which may be a terminal, and its internal structure diagram may be as shown in FIG. 3. The computer equipment includes a processor, a memory, a network interface, a display screen and an input device connected through a system bus. The processor of the computer equipment is used for providing computing and control capabilities. The memory of the computer equipment includes a readable storage medium and an internal memory. The nonvolatile storage medium stores an operating system and computer-readable instructions. The internal memory provides an environment for the operation of the operating system and computer-readable instructions in the readable storage medium. The network interface of the computer equipment is used to communicate with external servers through network connection. The computer-readable instructions, when executed by a processor, implement the brand value evaluation method. The readable storage medium provided by this embodiment includes a nonvolatile readable storage medium and a volatile readable storage medium.

In one embodiment, a computer equipment is provided, which includes a memory, a processor and a computer program stored in the memory and executable on the processor, and the processor implements the brand value evaluation method provided by the above embodiment when executing the computer program.

In one embodiment, a computer-readable storage medium is provided, on which a computer program is stored, and when the computer program is executed by a processor, the brand value evaluation method provided by the above embodiment is realized.

A person of ordinary skill in the art can understand that all or part of the processes in the method of the foregoing embodiments can be implemented by instructing related hardware through computer readable instructions, which can be stored in a nonvolatile computer readable storage medium, and the computer readable instructions can include the steps of the above embodiments. Wherein, any reference to memory, storage, database or other medium used in the embodiments provided in this application may include nonvolatile and/or volatile memory. The nonvolatile memory may include read-only memory (ROM), programmable ROM (PROM), electrically programmable ROM (EPROM), electrically erasable programmable ROM (EEPROM), or flash memory. The volatile memory may include random access memory (RAM) or external cache memory. As an illustration and not a limitation, RAM is available in many forms, such as static RAM (SRAM), dynamic RAM (DRAM), synchronous DRAM (SDRAM), double data rate SDRAM (DDRSDRAM), enhanced SDRAM (ESDRAM), synchronous link (Synchlink) DRAM (SLDRAM), memory bus, (Rambus) direct RAM (RDRAM), direct memory bus dynamic RAM (DRDRAM), and memory bus dynamic RAM (RDRAM), etc.

A person of ordinary skill in the art can clearly understand that, for the convenience and conciseness of description, the division of the above functional units and modules are only used as examples. In practical applications, the above functions may be implemented by different functional units and modules as needed. That is, the internal structure of the device may be divided into different functional units or modules to complete all or part of the functions described above.

The above embodiments are only used to illustrate the technical solutions of this application, but not to limit it. Although the application has been described in detail with reference to the aforementioned embodiments, those of ordinary skill in the art should understand that the technical solutions described in the aforementioned embodiments may still be modified, or some of the technical features may be equivalently replaced. However, these modifications or substitutions do not make the essence of the technical solutions deviate from the spirit and scope of the technical solutions of each embodiment of this application, and shall be included in the protection scope of this application.

What is claimed is:

1. A brand value evaluation method, comprising:
acquiring a brand set to be processed; the brand set to be processed comprises a plurality of brands to be processed;
collecting evaluation data corresponding to the brand set to be processed, and identifying the brand set to be processed based on the evaluation data to obtain a reputation degree and a volume of each brand to be processed in the brand set to be processed;
acquiring a brand to be evaluated, and judging whether the brand to be evaluated exists in the brand set to be processed;
when the brand to be evaluated exists, determining the reputation degree and volume of the brand to be evaluated as a target reputation degree and a target volume; and
determining a value for the brand to be evaluated according to the reputation degree of each brand to be processed, the volume of each brand to be processed, the target reputation degree and the target volume.

2. The brand value evaluation method of claim 1, wherein the step of collecting evaluation data corresponding to the brand set to be processed, and identifying the brand set to be processed based on the evaluation data to obtain a reputation degree and a volume of each brand to be processed in the brand set to be processed comprises:
collecting evaluation data corresponding to each brand to be processed in the brand set to be processed according to a preset data collection rule, and the evaluation data comprises social comment data and brand appearance frequency of each brand to be processed;
determining a reputation degree corresponding to each brand to be processed according to the social comment data of the brand to be processed; and
calculating to obtain a total brand appearance frequency corresponding to all the brands to be processed according to the brand appearance frequency, and determining a volume corresponding to each brand to be processed according to the brand appearance frequency corresponding to each brand to be processed and the total brand appearance frequency of all the brands to be processed.

3. The brand value evaluation method of claim 2, wherein the step of determining a reputation degree corresponding to each brand to be processed according to the social comment data of the brand to be processed comprises:
acquiring all social comment data corresponding to one single brand to be processed;
performing emotion recognition on each social comment data through a preset emotion recognition model to obtain an evaluation result corresponding to the social comment data, and the evaluation result comprises a positive evaluation result and a negative evaluation result; and
determining a reputation degree for the brand to be processed according to the positive evaluation result and the negative evaluation result respectively corresponding to all the social comment data.

4. The brand value evaluation method of claim 1, wherein after judging whether the brand to be evaluated exists in the brand set to be processed, the method further comprises:
when the brand to be evaluated does not exist, updating and adding the brand to be evaluated as a brand to be processed into the brand set to be processed;
collecting evaluation data corresponding to the brand to be evaluated according to a preset data collection rule to obtain a target reputation degree and a target volume corresponding to the brand to be evaluated; and
determining a value for the brand to be evaluated according to the reputation degree of each brand to be processed, the volume of each brand to be processed, the target reputation degree and the target volume.

5. The brand value evaluation method of claim 1, wherein the step of determining a value for the brand to be evaluated according to the reputation degree of each brand to be processed, the volume of each brand to be processed, the target reputation degree and the target volume comprises:
determining an average reputation degree for all brands to be processed according to the reputation degree of each brand to be processed;
determining an average volume for all brands to be processed according to the volume of each brand to be processed;
inputting the reputation degree of the brand to be evaluated, the volume of the brand to be evaluated, the average reputation degree and the average volume into a preset fine reputation value generation model to obtain a fine reputation value of the brand to be evaluated output by the fine reputation value generation model, and determining a value for the brand to be evaluated according to the fine reputation value.

6. The brand value evaluation method of claim 5, wherein the step of determining a value for the brand to be evaluated according to the fine reputation value further comprises:
decentralizing the fine reputation value of the brand to be evaluated to obtain a fine reputation value standard score of the brand to be evaluated; and
normalizing the fine reputation value standard score of the brand to be evaluated to obtain a fine reputation degree of the brand to be evaluated, and determining a value for the brand to be evaluated according to the fine reputation degree.

7. A brand value evaluation device, comprising:
a brand set acquisition module, configured to acquire a brand set to be processed; the brand set to be processed comprises a plurality of brands to be processed;
a brand set identification module, configured to collect evaluation data corresponding to the brand set to be processed, and identify the brand set to be processed based on the evaluation data to obtain a reputation degree and a volume of each brand to be processed in the brand set to be processed;
a brand to be evaluated judging module, configured to acquire a brand to be evaluated, and judge whether the brand to be evaluated exists in the brand set to be processed;
a brand to be evaluated determination module, configured to, when the brand to be evaluated exists, determine the reputation degree and volume of the brand to be evaluated as a target reputation degree and a target volume; and
a brand value determination module, configured to determine a value for the brand to be evaluated according to the reputation degree of each brand to be processed, the volume of each brand to be processed, the target reputation degree and the target volume.

8. The brand value evaluation device of claim 7, wherein the brand set identification module comprises:
a frequency calculation unit, configured to collect evaluation data corresponding to each brand to be processed in the brand set to be processed according to a preset data collection rule, and the evaluation data comprises social comment data and brand appearance frequency of each brand to be processed;
a reputation degree determination unit, configured to determine a reputation degree corresponding to each brand to be processed according to the social comment data of the brand to be processed; and
a volume determination unit, configured to calculate to obtain a total brand appearance frequency corresponding to all the brands to be processed according to the brand appearance frequency, and determine a volume corresponding to each brand to be processed according to the brand appearance frequency corresponding to each brand to be processed and the total brand appearance frequency of all the brands to be processed.

9. A computer equipment, comprising a memory, a processor and a computer program stored in the memory and executable by the processor, wherein when the processor executes the computer program, the brand value evaluation method of claim 1 is realized.

10. A compute readable storage medium, storing a computer program, wherein when the computer program is executed by a processor, the brand value evaluation method of claim 1 is realized.
